(19) United States
(12) Patent Application Publication
(10) Pub. No.: US 2007/0175228 A1
(43) Pub. Date: Aug. 2, 2007

(54) System, method, and apparatus for integrated cooling of a vehicle cabin and a personal climate system worn by an occupant thereof

(75) Inventor: Robert H. Tigner, Dalworthington Gardens, TX (US)

Correspondence Address: BRACEWELL & GIULIANI LLP, PO BOX 61389, HOUSTON, TX, 77208-1389, US

(73) Assignee: SCS Frigette

(21) Appl. No.: 11/341,308

(22) Filed: Jan. 27, 2006

(51) Int. Cl. F25D 17/02; B60H 1/32; F25D 23/12

(52) U.S. Cl. 62/201; 62/331; 62/244

(57) ABSTRACT

A system, method, and apparatus for the integrated cooling of a vehicle and the personal climate systems worn by its occupants allows the components of the vehicle's refrigeration system to provide simultaneous cooling for both the vehicle and the occupants. A portion of the refrigerant circulated through the refrigeration system is redirected to a heat exchanger that chills the fluid circulated through the personal climate systems.

### BACKGROUND OF THE INVENTION

1. Technical Field

The present invention relates in general to cooling systems and, in particular, to an improved system, method, and apparatus for the integrated cooling of both the cabin of vehicles and the personal climate systems worn by their occupants.

2. Description of the Related Art

In the prior art, ventilation and cooling systems for the interior cabins of automobiles (i.e., air conditioning) are well known. More recently, personal climate control systems in the form of a vest or suit that is worn by a person have been introduced. For example, a typical personal climate control system may use ice or batteries to provide direct cooling to the body of the user. Such additional cooling can be an important safety or performance issue for the wearer, as heat stress can bring fatigue or even fatal injury to the most highly trained and fit people in many types of applications, such as military and law enforcement operations. These systems can reduce the effects of heat stress as a result of environmental conditions, physical work rate, and required protective clothing. By removing internally generated metabolic heat and reducing the effects of environmental heat, users are better able to achieve their goal of mission success.

In some applications, personal climate control systems are provided with their own, stand-alone refrigeration systems. One such system comprises an enclosure containing a compressor, condenser, evaporator, and circulation system for providing cooling to the wearer of the climate-controlled suit. Although this design is workable, such systems themselves have a limited range of operation with respect to the environment. For example, if the stand-alone refrigeration system is exposed to excessive temperatures or is not well ventilated, it can overheat, which reduces its performance, or terminate operation altogether. Thus, an improved solution would be desirable.

### SUMMARY OF THE INVENTION

One embodiment of a system, method, and apparatus for the integrated cooling of a vehicle and one or more persons allows the components of the vehicle's refrigeration system to provide simultaneous cooling for both the vehicle and the personal climate systems worn by the vehicle's occupants. A portion of the refrigerant circulated through the vehicle's refrigeration system is redirected to a heat exchanger that chills the fluid (e.g., water) being circulated through the personal climate systems of the occupants. Thus, no additional compressor or condenser is needed. This solution is more compact than prior art designs and has a greater range of operation with respect to environmental operating temperatures. The present invention is readily adaptable for automobiles, aircraft, and other types of vehicles including a wide range of military applications.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the present invention, which will become apparent, are attained and can be understood in more detail, more particular description of the invention briefly summarized above may be had by reference to the embodiments thereof that are illustrated in the appended drawings which form a part of this specification. It is to be noted, however, that the drawings illustrate only some embodiments of the invention and therefore are not to be considered limiting of its scope as the invention may admit to other equally effective embodiments.

FIG. 1 is a schematic diagram of one embodiment of an integrated system constructed in accordance with the present invention; and

FIG. 2 is a high level flow diagram of one embodiment of a method constructed in accordance with the present invention.

### DETAILED DESCRIPTION OF THE INVENTION

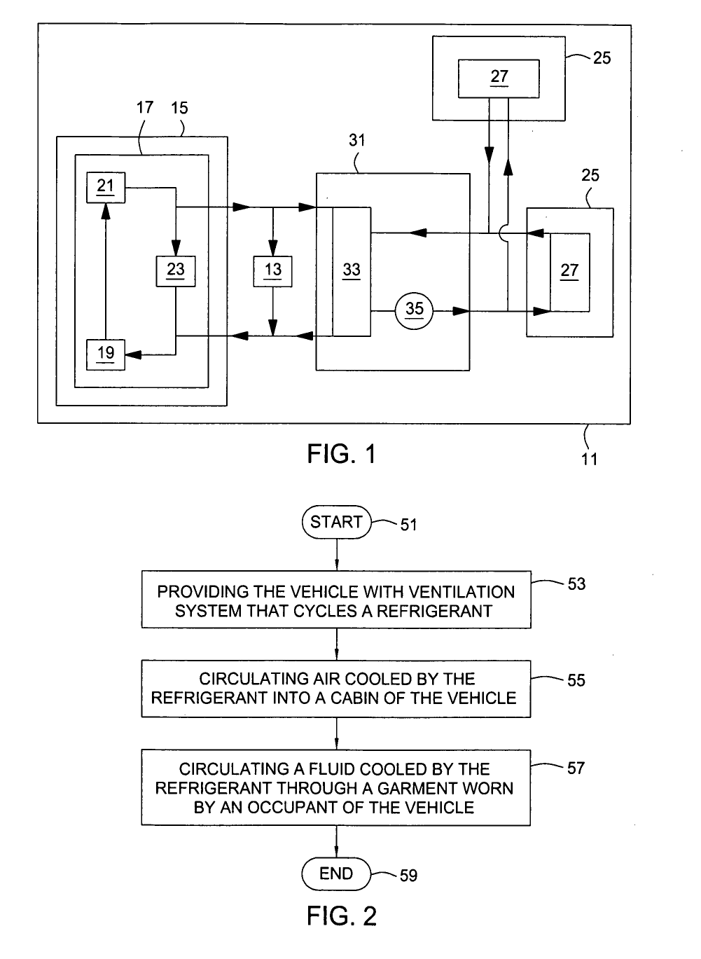

Referring to FIGS. 1 and 2, embodiments of a system, method, and apparatus for the integrated cooling of both the interior of a vehicle and a system for controlling the personal climate of an occupant of the vehicle is disclosed. In one embodiment, the present invention comprises a system including a vehicle 11 for transporting occupants thereof. The vehicle may comprise an automobile (e.g., cars, trucks, tanks, etc.), aircraft (e.g., helicopters, airplanes, etc.), and/or other types of military and civilian vehicles.

The vehicle 11 has an interior cabin 13 for accommodating occupants and/or passengers for transportation thereof. The vehicle 11 is equipped with a ventilation system 15 for cooling the interior cabin 13 of the vehicle 11 by cycling a refrigerant (e.g., R134A, R22, etc.) in a refrigeration system 17. The refrigeration system 17 may comprise a compressor 19, a condenser 21, and an evaporator 23 for cycling the refrigerant in a refrigeration cycle.

One embodiment of a system according to the present invention also comprises one or more garments 25, such as vests, that are worn by the occupants of the vehicle 11. Each garment 25 comprises a fluid circulation system 27 for circulating a fluid (e.g., water) through the garment 25 to cool the occupant wearing the garment 25.

The system also includes a “chiller” 31 that is mounted to the vehicle 11. The chiller 31 is connected to both the refrigeration system 17 of the ventilation system 15, and to the fluid circulation system 27 of the garment 25. The chiller 31 uses at least a portion of the refrigerant to reduce a temperature of the fluid in the fluid circulation system 27 of the garment 25. In one embodiment, the chiller 31 comprises a heat exchanger 33 for exchanging heat from the fluid circulation system 27 to the refrigeration system 17, and a pump 35 for pumping the fluid through the fluid circulation system 27. A control system having an electronics package, a fan for the cooling the electronics package, etc., also may be included. No other refrigeration components (e.g., compressor, condenser, etc.) are required in this embodiment. The chiller is integrated with the refrigeration system 17 and the fluid circulation system 27 and may provide simultaneous cooling of both the interior cabin 13 of the vehicle 11 and the occupant(s) wearing the garment(s) 25.

Referring now to FIG. 2, the present invention also comprises a method of conditioning an atmosphere in a vehicle. In one embodiment, the method begins as indicated at step 51, and comprises providing the vehicle with a ventilation system that cycles a refrigerant (step 53); circulating air cooled by the refrigerant into a cabin of the vehicle (step 55); circulating a fluid cooled by the refrigerant through a garment worn by an occupant of the vehicle (step 57); before ending as indicated at step 59. Step 57 may comprise exchanging heat from the fluid to the refrigerant, and pumping the fluid through the garment, and/or circulating the fluid to a plurality of vests, each of which is worn by one occupant of the vehicle. In addition, steps 57 and 59 may be performed simultaneously.

While the invention has been shown or described in only some of its forms, it should be apparent to those skilled in the art that it is not so limited, but is susceptible to various changes without departing from the scope of the invention. For example, the present invention is readily adaptable for heating purposes such that the heating ventilation system of a vehicle supplies and sustains heat to both the interior cabin of the vehicle and to the personal climate systems of its occupants simultaneously.

What is claimed is:

1. A system, comprising:
a vehicle for transporting occupants thereof, the vehicle having an interior cabin and a ventilation system for cooling the interior cabin of the vehicle by cycling a refrigerant in a refrigeration system;
a garment adapted to be worn by an occupant of the vehicle, the garment having a fluid circulation system for circulating a fluid to cool the occupant of the vehicle; and
a chiller mounted to the vehicle and connected to both the refrigeration system of the ventilation system and to the fluid circulation system of the garment, such that the chiller uses at least a portion of the refrigerant to reduce a temperature of the fluid in the fluid circulation system of the garment.

2. A system according to claim 1, wherein the chiller comprises a heat exchanger for exchanging heat from the fluid circulation system to the refrigeration system, and a pump for pumping the fluid through the fluid circulation system.

3. A system according to claim 1, wherein the vehicle is selected from the group consisting of automobiles and aircraft.

4. A system according to claim 1, wherein the garment comprises a plurality of vests, each of which is adapted to be worn by one occupant of the vehicle.

5. A system according to claim 1, wherein the chiller is integrated with the refrigeration system and the fluid circulation system to provide simultaneous cooling of both the interior cabin of the vehicle and the occupant wearing the garment.

6. A system according to claim 1, wherein the refrigeration system comprises a compressor, a condenser, and an evaporator.

7. A cooling system, comprising:
a ventilation system adapted to cool an interior cabin of a vehicle by cycling a refrigerant in a refrigeration system;
a garment adapted to be worn by an occupant of the vehicle, the garment having a fluid circulation system adapted to circulate a fluid to cool the occupant of the vehicle; and
a chiller adapted to be connected to both the refrigeration system of the ventilation system and to the fluid circulation system of the garment, such that the chiller is adapted to use at least a portion of the refrigerant to reduce a temperature of the fluid in the fluid circulation system of the garment.

8. A cooling system according to claim 7, wherein the chiller consists of a heat exchanger for exchanging heat from the fluid circulation system to the refrigeration system, and a pump for pumping the fluid through the fluid circulation system.

9. A cooling system according to claim 7, wherein the garment comprises a plurality of vests, each of which is adapted to be worn by one occupant of the vehicle.

10. A cooling system according to claim 7, wherein the chiller is integrated with the refrigeration system and the fluid circulation system and adapted to provide simultaneous cooling of both the interior cabin of the vehicle and the occupant wearing the garment.

11. A cooling system according to claim 7, wherein the refrigeration system comprises a compressor, a condenser, and an evaporator.

12. A method of conditioning an atmosphere in a vehicle, comprising:
(a) providing the vehicle with a ventilation system that cycles a refrigerant;
(b) circulating air cooled by the refrigerant into a cabin of the vehicle; and
(c) circulating a fluid cooled by the refrigerant through a garment worn by an occupant of the vehicle.

13. A method according to claim 12, wherein step (c) comprises exchanging heat from the fluid to the refrigerant, and pumping the fluid through the garment.

14. A method according to claim 12, wherein step (c) comprises circulating the fluid to a plurality of vests, each of which is worn by one occupant of the vehicle.

15. A method according to claim 12, wherein steps (b) and (c) are performed simultaneously.
